(19) United States
(12) Patent Application Publication
(10) Pub. No.: US 2016/0055657 A1
(43) Pub. Date: Feb. 25, 2016

(54) Electronic Color Processing Devices, Systems and Methods

(71) Applicant: Bloodhound, LLC, Chicago, IL (US)

(72) Inventors: Ilya Beyrak, Chicago, IL (US); Matthew Cole, Wilmette, IL (US)

(73) Assignee: BLOODHOUND, LLC, Chicago, IL (US)

(21) Appl. No.: 14/467,674

(22) Filed: Aug. 25, 2014

(51) Int. Cl. G06T 11/00; G09G 5/02; G06F 3/0484

(52) U.S. Cl. CPC G06T 11/001; G06F 3/0484; G09G 5/02; G06T 2200/24; G09G 2320/0666; G09G 2354/00

(57) ABSTRACT

An electronic color recognition and enhancement device, system, and method aiding a user in recognition of color based patterns. The electronic color recognition and enhancement device, system, and method generally include a user device, including a processor, a visual input component, and a visual output component adapted to capture or record visual information and modify the contrast and/or color of a portion of the visual information to allow the user to recognize certain colors and/or patterns that otherwise may be difficult to recognize.

### FIELD OF THE INVENTION

The present application relates to a visual computer program, and more specifically to an electronic color recognition and enhancement system for aiding in recognition of color-based patterns.

### BACKGROUND

Many computer programs provide visual effects to aid or enhance the visual experience. For example, many photography programs allow “filters” where users can see different visual effects as applied to their photographs. Other programs enhance contrast, brightness, or other visual parameters to alter a photograph or video to a user's liking.

Many people are colorblind such that they are unable to distinguish between red and green, and sometimes other colors. These colorblind individuals can include, for example, doctors and hunters who need to be able to detect the color of blood or distinguish between red and green surroundings. There exists a need for a computer program or system that detects red and green coloring and modifies it so a colorblind individual can detect the color using a tool other than the naked eye.

### SUMMARY

The present application discloses a method for detecting input colors and outputting the input colors in respective different colors that the user is better able to see the image represented by the colors. For example, the present application can include an application for a smart phone that detects red and green colors and outputs the image onto a screen in purple and yellow colors. Any other input or output colors can also be used without departing from the spirit and scope of the present application.

In an embodiment, a method for enhancing visual information is disclosed that includes capturing or receiving visual information and recognizing one or more input colors of the visual information. The input colors may then be modified based on one or more settings to produce modified visual information having output colors that the user is able to better see. This modified visual information is then displayed to the user.

In another embodiment, a device for enhancing visual information is disclosed that includes a visual input component adapted to capture visual information, a processor in communication with the visual input component, and a visual output component in communication with the processor and adapted to display modified visual information to a user. The processor is adapted to recognize one or more input colors of the visual information and modify the input colors based on a setting to produce the modified visual information having output colors the user is able to better see.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is an illustration of operation of a user device according to an exemplary embodiment of the present application.

FIG. 2 is a schematic diagram of exemplary components of the user device according to an exemplary embodiment of the present application.

FIG. 3 is a flow diagram of a method according to an exemplary embodiment of the present application.

### DETAILED DESCRIPTION OF THE EMBODIMENTS

Detailed embodiments of devices, systems, and methods are disclosed herein. However, it is to be understood that the disclosed embodiments are merely exemplary of the devices, systems, and methods, which may be embodied in various forms. Therefore, specific functional details disclosed herein are not to be interpreted as limiting, but merely as a basis for the claims and as a representative example for teaching one skilled in the art to variously employ the present disclosure.

The present application relates to user devices including a processor, a visual input component, and a visual output component. As described above, it can be difficult for some users to identify colors and/or patterns of an image due to low light situations, visual impairments (e.g., color blindness), and other reasons. In this respect, the visual input component may capture or record visual information, and the user device may modify the contrast and/or color of a portion of the visual information to allow the user to more easily identify certain patterns of the image. For example, the visual information may include red and green colors as input colors, and the visual output component may output the red and green colors of the visual information as purple and yellow output colors.

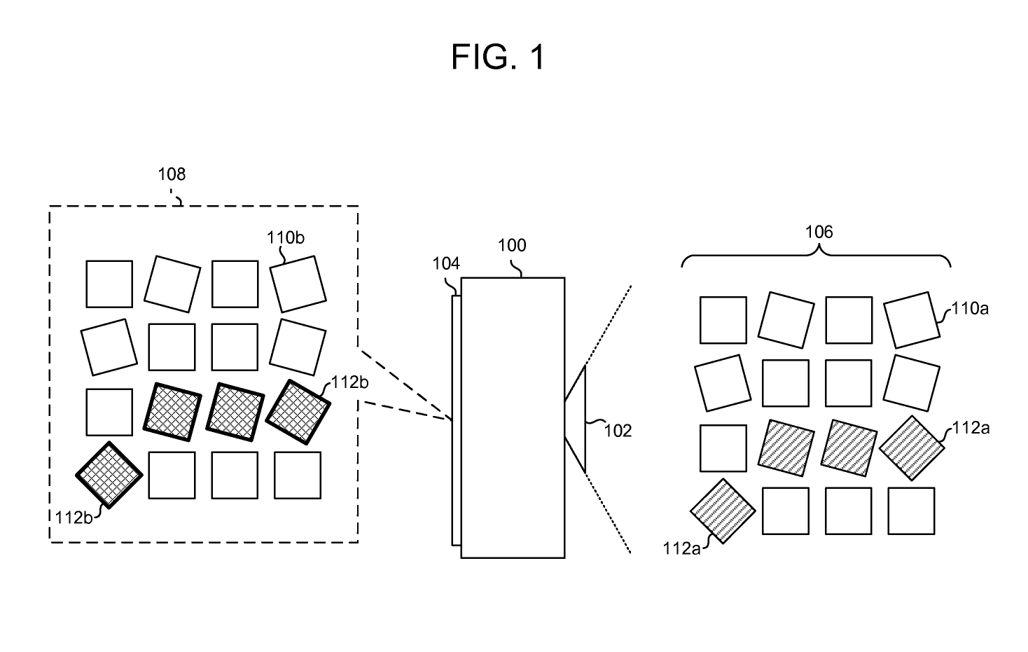

FIG. 1 illustrates an overview of operation of the devices, systems, and methods in accordance with an embodiment of the present application. As illustrated in FIG. 1, a user device 100 includes a visual input component 102 and a visual output component 104 for use in capturing visual information 106 (for example, images or video of a scene). The visual input component 102 may capture or record the visual information 106 and the user device 100 may sense an input color of the visual information 106 and produce modified visual information 108 having an output color in a color other than the input color. For example, the visual information 106 may include first objects 110a and second objects 112a, wherein the first and second objects 110a and 112a have a different color and/or contrast that is difficult to distinguish by the user. The user can therefore select the input colors that the user wishes to modify, for example, red and green, or the user device 100 can include default input colors not requiring any input by the user. The visual input component 102 may then capture or record the input colors, and output those colors via the visual output component 104 as a more easily detectible color, for example, purple and yellow. The visual output component 104 may therefore display the modified visual information 108 to a user on a display to allow the user to more easily identify certain patterns of the visual information 106.

The visual information 106 may be part of an environment in which the user has to quickly and readily identify color patterns. For example, the first objects 110a may be a background (e.g., the ground) and the second objects 112a may be traces of a substance (e.g., a chemical or blood) spilled on the ground. This would especially be the case with hunters who must identify blood to track wounded animals. In other examples, the second objects 112a may be veins of a human being and the first objects 110a may be blood of a patient during surgery. In this manner, surgeons would also benefit from the user device 100 and methods thereof.

As described above, the user device 100 may modify the sensed input color of one or more of the first and second objects 110a and 112a to produce modified visual information 108 having modified first and/or second objects 110b and 112b with output colors different than the first and second objects 110a and 112a. Such modification makes it easier for the user to identify such patterns if the user suffers from color blindness or other visual impairment. The user device may also increase the contrast between the first and second objects 110a and 112a by changing a input color of at least one of the first and second objects 110a and 112a to produce modified first and/or second objects 110b and 112b with more dramatically different output colors. For example, the user device 100 may change a red color to a blue color and/or change a green color to a yellow color, modify the contrast between colors, or remove colors, to make it easier for the user to distinguish one object from another.

The visual information 106 may be received and processed such that individual pixels of the image are analyzed to determine the input color thereof. For example, the visual information 106 can be analyzed on a pixel-by-pixel basis to determine the wavelength of the input color of each pixel or a selected portion of pixels of the image.

As discussed below, the user device 100 can then process the visual information 106 and change the color of the visual information 106 (either on a pixel by pixel basis, or more or less granular). In doing so, the user device 100 may change the visual information 106 based on a range of wavelengths associated with colors the user may not be able to see well. For example, the input color may be a wavelength of 680 nm±a sensitivity value of 60 nm. The user can also control whether neighboring pixels are modified using the color modification process to control noise in the image or for other visual enhancement purposes.

The user device 100 may be a device of any type that allows for the capturing of visual information and processing of the visual information into modified visual information. By way of example, the user device 100 may be any type of computing device, for example, including, but not limited to, a smartphone, personal computer (e.g., a tablet laptop, or desktop computer), camera, video camera, wearable device, video telephone set, streaming audio and video media player, integrated intelligent digital television receiver, work station, personal digital assistant (PDA), mobile satellite receiver, software system, or any combination of the above.

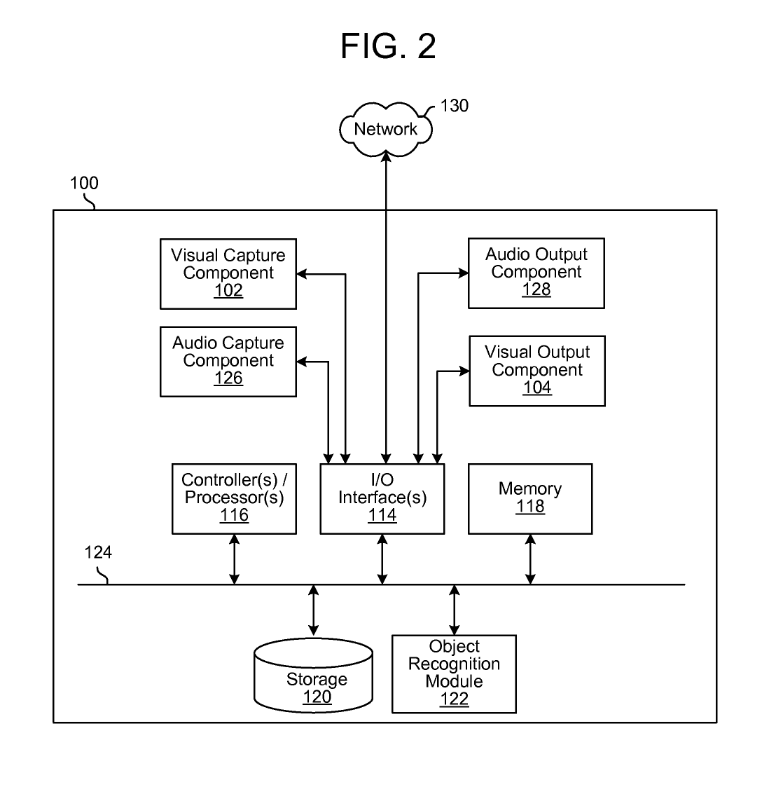

FIG. 2 is a schematic diagram of exemplary components of the user device 100. As illustrated, the user device 100 may include an input/output interface(s) 114, a controller/processor 116, a memory 118, storage 120, and an object recognition module 122 connected via an address/data bus 124 for communicating data among components of the user device 100.

The input/output interface 114 allows the user to input information or commands into the user device 100 and to transmit information or commands to other devices and/or servers via a network 130. By way of example, the input/output interface 114 can include a keyboard, mouse, touch screen, number pad, or any other device that allows for the entry of information from a user.

The network 130 may be a wired or wireless local area network, Bluetooth, and/or a wireless network radio capable of communication with a wireless communication network such as a Long Term Evolution (LTE) network, WiMAX network, 3G network, and so forth. Any structure allowing uses to communicate can correspond to the network 130.

One or more additional devices or components may also be coupled to the input/output interface 114. The user device 100 may include one or more input and/or output components, for example, the visual input component 102 and the visual output component 104, and optionally an audio capture component 126 (e.g., one or more microphones) and an audio output component 128 (e.g., one or more speakers), all of which may be connected to the other components of the user device 100 via the input/output interface(s) 114 and the address/data bus 124.

The visual input component 102 may be any device or structure that is capable of sensing an image or series of images, or individual pixels from an image. For example, the visual input component 102 can be a camera, video camera, photosensitive array, charge coupled device, or any other device capable of sensing an image.

The visual output component 104 may be any device or structure capable of displaying information to the user, including captured visual information and modified visual information (e.g., captured and modified images and/or video), live streaming video and modified live streaming video, or images and video of the system on which the user device 100 operates. For example, the visual output component 104 can display various menus and options for the user to input information via the input/output interface 114, similar to a touch screen. By way of example, the visual output component 104 may be a liquid crystal display (LCD), organic light emitting diode (OLED) display, plasma screen, or any other kind of black and white or color display that will allow the user to view and interpret information on the user device 100.

The processor 116 may facilitate communications between the various components of the user device 100 and be adapted to process data and computer-readable instructions. The processor 116 can be any type of processor or processors that alone or in combination can facilitate communication within the user device 100 and cause the transmission of information from the user device 100 to external devices. For example, the processor 116 can be a desktop or mobile processor, a microprocessor, a single-core or a multi-core processor.

The memory 118 and/or storage 120 may store data and instructions, such as executable instructions, for use by the processor 116 and other components of the user device 100. The memory 118 and/or storage 120 may include a non-transitory computer-readable recording medium, such as a hard drive, DVD, CD, flash drive, volatile or non-volatile memory, RAM, or any other type of memory or data storage. As used throughout this application, the term “non-transitory computer-readable recording medium” excludes only signals and carrier waves, per se, and is not meant to exclude other types of memory that may be considered “transitory” such as RAM or other forms of volatile memory.

In an example, the memory 118 and/or storage 120 may store user settings and/or pre-set settings for use in analyzing visual information and creating the modified visual information. The memory 118 and/or storage 120 may also store an operating system for the user device 100 or any other software or data that may be necessary for the user device 100 to function.

The object recognition module 122 may include instructions executable by the processor 116 and/or be adapted to generate or create the modified visual information 108 for display to the user via the visual output component 104. More particularly, the object recognition module 112 may receive digital information representing an image captured by the visual input component 102 (e.g., pixels of an image) and the input colors of the image or pixels may be recognized and/or parsed. The object recognition module 122 and/or processor 116 may then modify, alter, or exclude one or more of the input colors to produce modified visual information 108 having output colors different than the input colors. For example, the user may program the user device 100, through the interface 114, to detect red and green input colors and to have the object recognition module 122 change those input colors to output colors, e.g., purple and yellow.

In general, a color results from a wavelength or band of wavelengths on the electromagnetic spectrum. The spectrum can be divided up into colors, such as, red, orange, yellow, green, blue, and violet. The wavelength of red light is generally about 620 nm to about 740 nm. The wavelength of orange light is generally about 590 nm to about 620 nm. The wavelength of yellow light is generally about 570 nm to about 590 nm. The wavelength of green light is generally about 495 nm to about 570 nm. The wavelength of blue light is generally about 450 nm to about 495 nm. The wavelength of violet light is generally about 310 nm to about 450 nm.

The object recognition module 122 and/or processor 116 is adapted to recognize and detect the color(s) and/or wavelength(s) of colors present in an image, video, or other visual information input captured by the user device 100 or an image or video received by or communicated to the user device 100 from another device, for example, via the network 130. The modification, alteration, or exclusion of input colors may be performed based on user settings or pre-set settings of the user device 100.

An example of a user setting may include a setting to modify red colors and green colors to be more easily distinguishable from one another (i.e., allowing a user to set red and green as the input colors that will be modified when output to the user on the visual output component 104 as output colors). The user setting may be set by the user to modify a specific range of wavelengths of colors based on user input. For example, even though the wavelength of red light is generally about 620 nm to about 740 nm, the user can set the user setting to sense and modify red light between 660 nm to 700 nm so as to make the sensing and modification features less sensitive. The user can store these settings as a user profile, for example, a first profile for when the user is hunting (with less sensitive settings) and a second profile for when the user is performing surgery (with more sensitive settings).

Similar to the above, the pre-set settings may be time dependent and may automatically change based on the time. For example, the pre-set settings may recognize different input colors under different lighting conditions, for example, the time of a day, season of a year, weather conditions as input from an external source, or other such external factors. The user can choose to implement this automatic feature or leave the preset settings as manual as he or she likes.

The bus 124 acts as the internal circuitry of the user device 100 and electrically connects the various components of the user device 100. The bus 124 can be any structure that performs such a function.

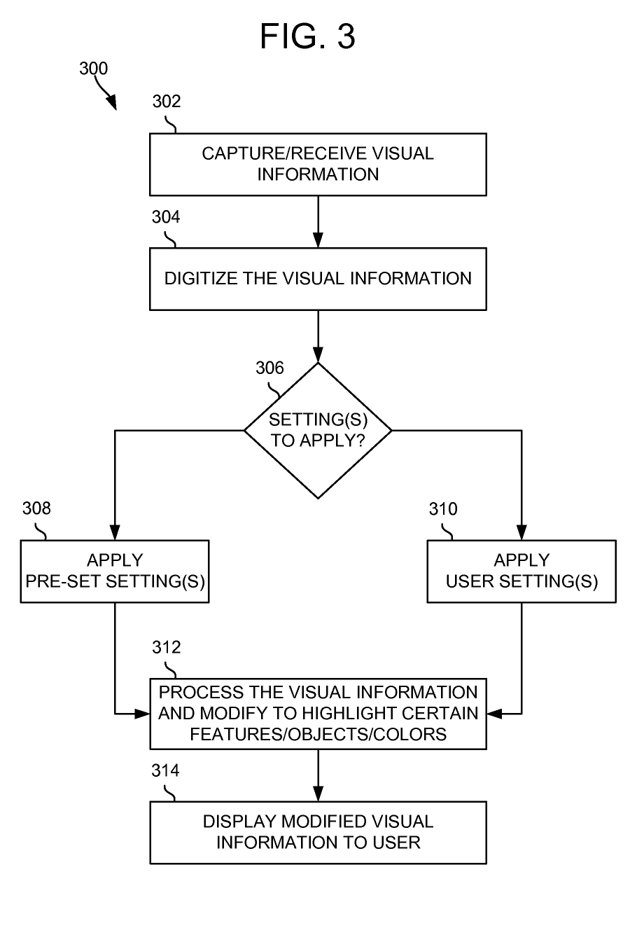

FIG. 3 illustrates a flow diagram of a method 300 according to an exemplary embodiment of the present application. As described above, a user may be posed with the task of or have difficulty recognizing various colors such as red and green. To aid the user in recognizing distinct objects or patterns present in the visual information, the user may use the user device described above. For example, the user may cause the user device to receive visual information and/or aim or position the user device to capture visual information within a field of view of the user device. The user device 300 may then perform the method 300 set forth below.

As illustrated in FIG. 3, at step 302, visual information 106 is captured or received. The captured/received visual information may be images, video, live streaming images or video via the network, or any combination thereof. The visual input component 102 may capture the visual information 106, or in the case of live streaming, the visual information 106 may be received from another device via the network.

The visual information 106 is then digitized, illustrated as step 302, for example, by the processor and/or the object recognition module 122, and a determination is made as to which setting(s) to apply to the visual information 106, illustrated as step 306. Pre-set settings, as described above, may be applied, illustrated as step 308; or user settings, as described above, may be applied, illustrated as step 310. For example, it can be determined that the input colors of the visual information 106 will be modified according to default output colors (step 308) or user-designated output colors (step 310).

The visual information 106 is then processed and modified, based on the setting(s) to highlight certain features, objects, and/or colors of the visual information 106, illustrated as step 312. For example, based on the setting(s), the processor and/or object recognition module may recognize the input colors and/or wavelength present in the visual information 106 and modify the visual information 106, as described above, to highlight or modify, alter, or exclude one or more of the input colors to produce modified visual information 108.

The modified visual information 108 is then displayed to the user, illustrated as step 314. For example, the modified visual information 108 may be displayed by the visual output component 104, described above, having the output colors defaulted into the user device 100 or set by the user. As described above, this presents the user with a display of the modified visual information 108 that allows the user to easily distinguish, identify, and locate objects and other features that may have otherwise been difficult for the user to notice.

The above steps are discussed and illustrated as occurring in a particular order, but the present disclosure is not so limited. The steps can occur in any logical order and any of the individual steps are optional and can be omitted. The order of the steps in the claims below are also not limiting unless clearly specified in the claims.

Aspects of the present disclosure may be implemented as a computer implemented method in a computing device or computer system, and in a wide variety of operating environments. The present disclosure may be implemented as an article of manufacture such as a memory device or non-transitory computer readable storage medium. The computer readable storage medium may be readable by a computer and may comprise instructions for causing a computer or other device to perform the methods described above. The present disclosure may also be implemented as part of at least one service or Web service, such as by communicating messages in extensible markup language (XML) format and using an appropriate protocol (e.g., a Simple Object Access Protocol).

Although the devices, systems, and methods have been described and illustrated in connection with certain embodiments, many variations and modifications should be evident to those skilled in the art and may be made without departing from the spirit and scope of the present disclosure. The present disclosure is thus not to be limited to the precise details of methodology or construction set forth above as such variations and modification are intended to be included within the scope of the present disclosure. Moreover, unless specifically stated any use of the terms first, second, etc. do not denote any order or importance, but rather the terms first, second, etc. are merely used to distinguish one element from another.

What is claimed is:

1. A method for modifying visual information, comprising:
establishing an input color as one of a default color and a selected color entered by a user into an interface;
receiving, by a user device, visual information with features having at least the input color;
recognizing, by the user device, the input color within the visual information;
modifying, by the user device, the input color based on a setting, resulting in modified visual information having an output color replacing the input color, the output color being based on the setting; and
displaying, by the user device, the modified visual information to the user.

2. The method of claim 1, wherein the recognizing step includes recognizing the input color of a plurality of objects of the visual information.

3. The method of claim 1, further comprising digitizing the visual information.

4. The method of claim 1, wherein the modifying step includes at least one of changing the input color and excluding the input color of the visual information.

5. The method of claim 1, wherein the setting includes specifying, for the input color, a specified range of wavelengths of the input color that will be subject to the step of modifying.

6. The method of claim 1, wherein the setting includes a user profile stored in a memory and having a preset input for the input color.

7. The method of claim 6, wherein the preset input includes at least one of recognizing the input color during a time of day, a season of a year, and a weather condition.

8. The method of claim 1, wherein the default color is one of red and green.

9. The method of claim 1, wherein the modifying step includes changing an input color of red to an output color of blue.

10. The method of claim 1, wherein the modifying step includes changing an input color of green to an output color of yellow.

11. The method of claim 1, wherein the visual information is at least one of an image captured by the user device, a video captured by the user device, an image received by the user device via a network, and a video received by the user device via the network.

12. A device for enhancing visual information, comprising:
a visual input component adapted to receive visual information;
a processor in communication with the visual input component, the processor adapted to:
establish an input color as one of a default color and a selected color entered by a user into an interface;
receive, by a user device, visual information with features having at least the input color;
recognize, by the user device, the input color within the visual information;
modify, by the user device, the input color based on a setting, resulting in modified visual information having an output color replacing the input color, the output color being based on the setting; and
display, by the user device, the modified visual information to the user.

13. The device of claim 12, wherein the processor is adapted to recognize the input color of a plurality of objects of the visual information.

14. The device of claim 12, wherein the processor is further adapted to digitize the visual information.

15. The device of claim 12, wherein the processor is further adapted to exclude the input color of the visual information.

16. The device of claim 12, wherein the setting includes specifying, for the input color, a specified range of wavelengths of the input color that will be subject to the step of modifying.

17. The device of claim 16, wherein the preset input includes at least one of recognizing the input color during a time of day, a season of a year, and a weather condition.

18. The device of claim 12, wherein the default input color is one of red and green.

19. The device of claim 12, wherein the visual information is at least one of an image captured by the user device, a video captured by the user device, an image received by the user device via a network, and a video received by the user device via the network.
